(19) United States
(12) Patent Application Publication
(10) Pub. No.: US 2026/0241493 A1
(43) Pub. Date: Aug. 20, 2026

(54) INTELLIGENT WELDING FOR MAGNETIC PROPERTY MANAGEMENT

(71) Applicant: International Business Machines Corporation, ARMONK, NY (US)

(72) Inventors: Heather Nicole Polgrean, Lagrangeville, NY (US); Alma Gabriela Ramirez Enriquez, Guadalajara (MX); Sarbajit Kumar Rakshit, Kolkata (IN); Carolina Garcia Delgado, Guadalajara (MX)

(21) Appl. No.: 19/055,655

(22) Filed: Feb. 18, 2025

(51) Int. Cl. B23K 31/00; B23K 31/02; B23K 31/12; B23K 37/003

(52) U.S. Cl. CPC B23K 31/006; B23K 31/02; B23K 31/125; B23K 37/003

(57) ABSTRACT

A method, computer system, and a computer program product for intelligent welding is provided. The present invention may include identifying one or more portions of a workpiece for which welding is to be performed. The present invention may include generating a plurality of welding parameters. The present invention may include welding, utilizing a welding device, the one or more portions of the workpiece according to the plurality of welding parameters. The present invention may include monitoring the welding of the one or more portions of the workpiece based on real-time multi-sensor data received. The present invention may include adjusting the welding of the one or more portions of the workpiece in response to the real-time multi-sensor data received.

### BACKGROUND

The present invention relates generally to the field of computing, and more particularly to intelligent workflow solutions.

Welding various structures of different sizes and materials requires precise planning and execution. The importance of this planning and execution is particularly crucial in scenarios in which the welding may affect the magnetic properties of the workpiece being welded as well as surrounding structures which may rely on magnetic sensors and/or devices for precise magnetic field measurements, which may lead to inaccurate readings or malfunctions. Furthermore, the welded area may potentially impact surrounding magnetic shielding if the magnetically active area penetrates that magnetic shielding which may lead to issues, such as, but not limited to, ferrite formation.

Accordingly, welding can lead to critical operational failures, costly replacements or extended downtimes, inaccurate data reading, corrosion, reduced service life, and safety concerns, if the input parameters for the welding process fail to consider the magnetic properties of both the workpiece in which the welding is to be performed and the surrounding environment.

### SUMMARY

Embodiments of the present invention disclose a method, computer system, and a computer program product for intelligent welding. The present invention may include identifying one or more portions of a workpiece for which welding is to be performed. The present invention may include generating a plurality of welding parameters. The present invention may include welding, utilizing a welding device, the one or more portions of the workpiece according to the plurality of welding parameters. The present invention may include monitoring the welding of the one or more portions of the workpiece based on real-time multi-sensor data received. The present invention may include adjusting the welding of the one or more portions of the workpiece in response to the real-time multi-sensor data received.

In another embodiment, the method may include generating a digital twin of an industrial floor, wherein the digital twin includes a model of the workpiece and real-world capabilities of a plurality of welding equipment designated by a user within a user interface. In this embodiment, the plurality of welding parameters may be generated based on trial-and-error simulations which utilize the digital twin and historical data as input. The welding equipment which may be designated by the user may include welding devices, such as, welding torches, welding machines, wire feed welders, gas metal arc welding (GMAW) welding machines, metal inert gas (MIG) welding machines, metal active gas (MAG) welding machines, tungsten inert gas (TIG) welders, AC/DC welders, dual voltage welders, gas tungsten arc welding (GTAW) welders, flux-corded arc welding (FCAW) machines, plasma arc welding machines, atomic hydrogen welding machines, laser beam welding machines, resistance welding machines, oxyfuel welding machines, electroslag welding machines, fillet welding machines, stick welding machines, amongst other welding devices. The welding equipment may also include other equipment, which may include but is not limited to including, angle grinders, chipping hammers, wire brushes, metal files, metal brushes, welding clams, welding magnets, transportation machines, clamping machines, welding safety equipment, amongst other equipment which may be utilized in welding.

Other embodiments of the present invention disclose a method, computer system, and a computer program product for managing magnetic properties during welding repair activities. The present invention may include identifying one or more portions of a workpiece for welding using non-destructive testing techniques to map the workpiece and detect areas requiring repair, wherein the workpiece is located in a repair area of the industrial floor. The present invention may include simulating effects of potential magnetic field changes prior to the welding being performed. The present invention may include positioning secondary electromagnetic particles during the welding process to counteract the potential magnetic field changes identified prior to the welding. The present invention may include integrating a coordinated control system with a welding system to control ferrite formation during the welding process, wherein the coordinated control system includes at least a heating treatment module and a cooling treatment module. The present invention may include performing at least one heating treatment or a least one cooling treatment using the coordinated control system during the welding process of the workpiece.

In another embodiment, the method may include generating a digital twin of the workpiece and surrounding magnetic-sensitive equipment in the repair area of the industrial floor using laser scanning technology or photogrammetry and integrating the digital twin with historical data and using the digital twin with finite element analysis software to determine the positioning of the secondary electromagnetic particles.

In a further embodiment, the method may include analyzing data from at least one or more magnetic flux sensors and one or more eddy current testers to identify ferrite formation during the welding process, and implementing at least one post-weld treatment to refine a microstructure and optimize magnetic properties of the one or more portions of the workpiece.

In addition to a method, additional embodiments are directed to a computer system and a computer program product for intelligent welding by controlling ferrite formation and managing magnetic properties of both a workpiece and surrounding assets during the welding process by leveraging historical learning to simulate the effects of changes in resultant magnetic fields. Further embodiments are directed to a computer system and computer program product for intelligent welding by proactively managing ferrite formation and adverse magnetic effects from welding by proactively deploying secondary electromagnetic particle shields and controlling the environment of the welding process using a coordinated control system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment;

FIG. 2 is an operational flowchart illustrating a process for intelligent welding according to at least one embodiment; and

FIG. 3 depicts an exemplary industrial floor environment according to at least one embodiment.

### DETAILED DESCRIPTION

The following described exemplary embodiments provide a system, method and program product for intelligent welding. As such, the present embodiment has the capacity to improve the technical field of intelligent welding by controlling ferrite formation and managing magnetic properties of both a workpiece and surrounding assets during the welding process by leveraging historical learning to simulate the effects of changes in resultant magnetic fields. More specifically, the present invention may include identifying one or more portions of a workpiece for which welding is to be performed. The present invention may include generating a plurality of welding parameters. The present invention may include welding the one or more portions of the workpiece according to the plurality of welding parameters. The present invention may include monitoring the welding of the one or more portions of the workpiece based on real-time multi-sensor data received. The present invention may include adjusting the welding of the one or more portions of the workpiece in response to the real-time multi-sensor data received.

According to an aspect of the invention, there is provided an invention that generates a plurality of welding parameters before a welding process begins. The inventions utilizes one or more machine learning models to simulate different welding scenarios and predict their outcomes before welding begins, such that the invention can weld one or more portions of the workpiece according to the plurality of parameters that ensure optimal magnetic property management and ferrite formation during the welding process. Additionally, the invention is capable of both monitoring the welding and adjusting the welding during the welding process to adapt in real time. The data gathered during the monitoring of the welding process as well as the adjustments made are utilized in retraining the one or more machine learning models to refine the plurality of welding parameters for the present weld and/or future welds to be performed. The one or more machine learning models may be trained using standard reference samples with known ferrite content and magnetic properties and the simulations performed may be validated against experimental welding data to ensure accuracy.

In embodiments, the invention may also generate a digital twin of the industrial floor which may include at least a model of the workpiece and the real-world capabilities of a plurality of welding equipment designated by a user within a user interface. This may enable the invention to generate welding parameters according to the real world capabilities of the welding equipment based on more accurate simulations and predictions.

In embodiments, the invention may be able to directly control the welding of the one or more portions of the workpiece using automated machines. The ability to control these automated machines may enable the invention to improve response times and perform real-time welding adjustments. The ability to utilize automated machines in combination with the one or more machine learning models enables the invention to predict magnetic field redistribution, optimize downtime of machines, equipment, or processes being performed, and automatically deploy robotic support mechanisms. This comprehensive approach ensures maintenance of critical magnetic characteristics while minimizing operational disruptions. The ability of the invention to enhance weld quality and automate the welding process further allows for a safer welding process, particularly in sensitive environments.

The following described exemplary embodiments provide a system, method and program product for managing magnetic properties during welding repair activities. As such, the present invention has the capacity to improve the technical field of intelligent welding by proactively managing ferrite formation and adverse magnetic effects from welding by proactively deploying secondary electromagnetic particle shields and controlling the environment of the welding process using a coordinated control system. More specifically, the present invention may include identifying one or more portions of a workpiece for welding using non-destructive testing techniques to map the workpiece and detect areas requiring repair, wherein the workpiece is located in a repair area of the industrial floor. The present invention may include simulating effects of potential magnetic field changes prior to the welding being performed. The present invention may include positioning secondary electromagnetic particles during the welding process to counteract the potential magnetic field changes identified prior to the welding. The present invention may include integrating a coordinated control system with a welding system to control ferrite formation during the welding process, wherein the coordinated control system includes at least a heating treatment module and a cooling treatment module. The present invention may include performing at least one heating treatment or a least one cooling treatment using the coordinated control system during the welding process of the workpiece.

According to an aspect of the invention, there is provided an intelligent welding invention that identifies one or more portions of a workpiece for welding, simulates effects of potential magnetic field changes prior to welding being performed, and proactively positions secondary electromagnetic particles during the welding process. The ability of the invention to consider the feasibility of using secondary electromagnetic components to counteract any undesired changes in magnetic properties and proactively position these secondary electromagnetic particles allows the invention to effectively maintain the desired magnetic properties of both the workpiece and surrounding machines, equipment, and/or components within the repair area of the industrial floor. The predictive capabilities and implementable countermeasures described in the invention provide effective magnetic property maintenance over the current state of the art.

According to another aspect of the invention, the integrated coordinated control system further enables control over ferrite formation and changes in magnetic properties during the welding process. The integrated coordinated control system of the invention includes at least a heating treatment module and a cooling treatment module, with at least one of the modules being utilized during the welding process. As the invention continuously monitors various parameters during the welding process, such as, but not limited to, temperature, cooling rate, and magnetic field strength, this real-time data may be compared against the simulated predictions to ensure the welding process is proceeding as expected. If deviations are detected, the invention may automatically adjust the welding parameters, cooling rates, or heat treatments to maintain optimal conditions for ferrite formation control and magnetic property management.

In embodiments, the invention may generate a digital twin of the workpiece and surrounding magnetic-sensitive equipment in the repair area of the industrial floor. This digital twin may be integrated with historical welding data. The digital twin may then be leveraged in conjunction with one or more machine learning models and finite element analysis software to determine optimal position of the secondary electromagnetic particles for ferrite formation control and magnetic property management.

In embodiments, the invention may also analyze from magnetic flux sensors and eddy current testers to identify ferrite formation during the welding process. The invention may also implement post-weld treatments to refine a microstructure and optimize magnetic properties of the portions of the workpiece being repaired.

As described previously, the present invention may include identifying one or more portions of a workpiece for which welding is to be performed. The present invention may include generating a plurality of welding parameters. The present invention may include welding, utilizing a welding device, the one or more portions of the workpiece according to the plurality of welding parameters. The present invention may include monitoring the welding of the one or more portions of the workpiece based on real-time multi-sensor data received. The present invention may include adjusting the welding of the one or more portions of the workpiece in response to the real-time multi-sensor data received.

Therefore, it may be advantageous to, among other things, identify one or more portions of a workpiece for which welding is to be performed, generate a plurality of welding parameters, weld the one or more portions of the workpiece according to the plurality of welding parameters, monitor the welding of the one or more portions of the workpiece based on real-time multi-sensor data received, and adjust the welding of the one or more portions of the workpiece in response to the real-time multi-sensor data received.

Also described previously, the present invention may include identifying one or more portions of a workpiece for welding using non-destructive testing techniques to map the workpiece and detect areas requiring repair, wherein the workpiece is located in a repair area of the industrial floor. The present invention may include simulating effects of potential magnetic field changes prior to the welding being performed. The present invention may include positioning secondary electromagnetic particles during the welding process to counteract the potential magnetic field changes identified prior to the welding. The present invention may include integrating a coordinated control system with a welding system to control ferrite formation during the welding process, wherein the coordinated control system includes at least a heating treatment module and a cooling treatment module. The present invention may include performing at least one heating treatment or a least one cooling treatment using the coordinated control system during the welding process of the workpiece.

Therefore, it may be advantageous to, among other things, identify one or more portions of a workpiece for welding using non-destructive testing techniques to map the workpiece and detect areas requiring repair, wherein the workpiece is located in a repair area of an industrial floor, simulate effects of potential magnetic field changes prior to the welding being performed, position secondary electromagnetic particles during the welding process to counteract the potential magnetic field changes identified prior to the welding, integrate a coordinated control system with a welding system to control ferrite formation during the welding process, wherein the coordinated control system includes at least a heating treatment module and a cooling treatment module, and perform at least one heating treatment or at least one cooling treatment using the coordinated control system during the welding process of the workpiece.

According to at least one embodiment, the present invention may improve upon traditional welding methods which may unpredictably alter magnetic properties of equipment, machines, and/or other components surrounding a workpiece that is being welded. The invention utilizes intelligent magnetic field control to dynamically manage magnetic fields during welding, which may enable surrounding equipment, machines, and/or components to maintain their intended magnetic characteristics, which may reduce the risk of operational failures in sensitive equipment.

According to at least one embodiment, the present invention may improve upon traditional welding methods by minimizing downtime by leveraging historical data and AI-driven predictions, the invention may enable the continuous operation of magnetic sensitive areas during repairs, which may significantly reduce costly downtimes in crucial industries such as nuclear power or aerospace, amongst other industries.

According to at least one embodiment, the present invention may improve upon traditional welding methods by providing enhanced weld quality by integrating cooling and heating treatment modules which may work in synchronization with the welding process enabling improved control over ferrite formation, which may result in welds with optimized mechanical properties and improved corrosion resistance.

According to at least one embodiment, the present invention may improve upon traditional welding methods by integrating adaptive and predictive capabilities. The invention’s ability to simulate magnetic field changes and predict redistribution allows for proactive measure, such as deploying secondary shielding or adjusting repair strategies, which improves consistent performance across various repair scenarios.

According to at least one embodiment, the present invention may improve upon the quality assurance measures of traditional welding methods by incorporating advanced technologies like magnetic field penetration for post-weld evaluation, such that the invention may allow for more thorough assessments of weld integrity than conventional methods which may be critical across various industries.

According to at least one embodiment, the present invention may minimize operational downtime and costs associated with workpiece welding maintenance by predicting magnetic field redistribution and dynamically managing the magnetic properties during repairs, allowing for critical operations, such as, but not limited to, nuclear reactors, aerospace systems, to continue without shutdowns which reduces costly downtime and enhances operational efficiency. The invention additionally improves resource efficiency by intelligently segmenting repair areas and simulating field changes, the invention optimizes the deployment of shielding mechanisms which reduces the time and labor costs associated with these repair activities. The invention uses historical data to predict how the magnetic field around the repair area will redistribute and deploys robotic systems to place temporary magnetic shielding around the repair area. The invention additionally controls a plurality of Internet of Things (IoT) devices and heating and cooling systems to maintain the environment of the repair area directly, allowing the repair work to continue without requiring a complete shutdown of the controlled systems.

According to at least one embodiment, the present invention enhances equipment performance and longevity by preserving magnetic characteristics and control corrosion and toughness. The invention accomplishes these improvements by preventing the formation of ferrite during welding and maintaining the original magnetic permeability of components which ensures long-term performance and reliability, especially in magnetic sensitive equipment like transformers and/or sensors. Furthermore, the integrated heating and cooling treatments during the welding improve the mechanical and corrosion resistance properties of the repair. These heating and cooling treatments which are directly controlled by the invention leverage the predictive capabilities of the one or more machine learning models employed by the invention allowing for real time pro-active and re-active treatments which may extend the service life of the components in harsh environments.

According to at least one embodiment, the present invention improves safety and precision in the welding process for critical applications, specifically in high risk industries. In environments like nuclear reactors and aerospace systems where electromagnetic shieling is critical, the invention ensures repairs do not comprise safety by preserving magnetic field integrity during welding.

According to at least one embodiment, the present invention improves the sustainability and cost efficiency of welding repairs. The invention utilizes both heating and cooling treatments in real-time such that the invention reduces rework and material waste while saving energy which may be aligned with the sustainability goals in manufacturing operations.

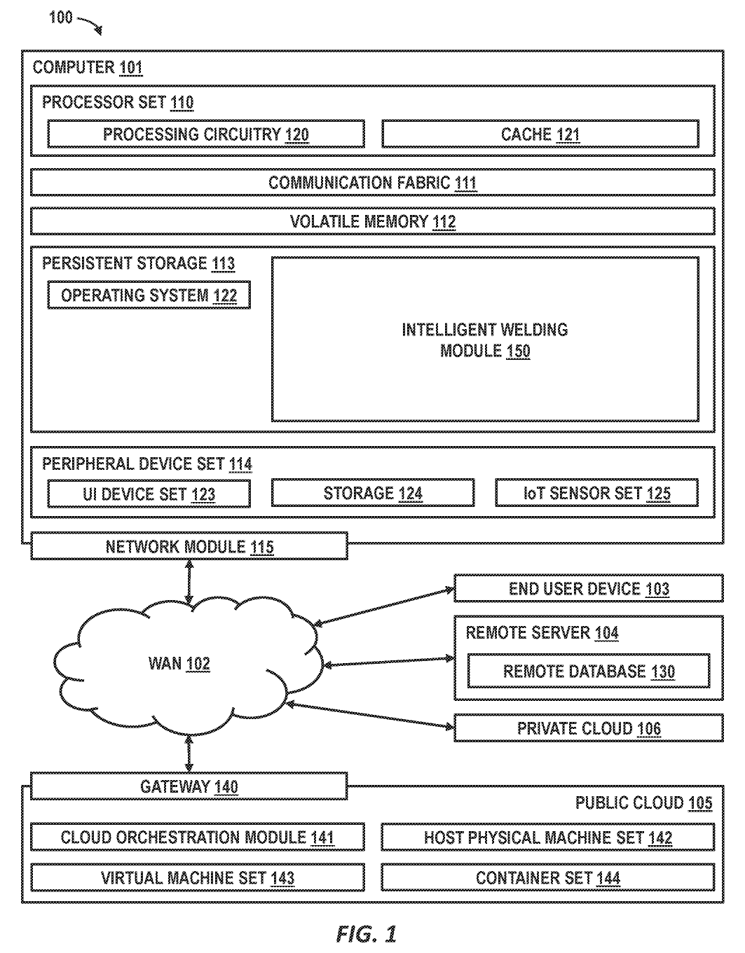

Referring to FIG. 1, Computing environment 100 contains an example of an environment for the execution of at least some of the computer code involved in performing the inventive methods, such as intelligent welding that manages magnetic properties during repair activities such that the intelligent welding module 150 evaluates the impact of welding on magnetic properties, simulates field changes, and dynamically positions secondary electromagnetic components and controls integrated heating and cooling systems. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

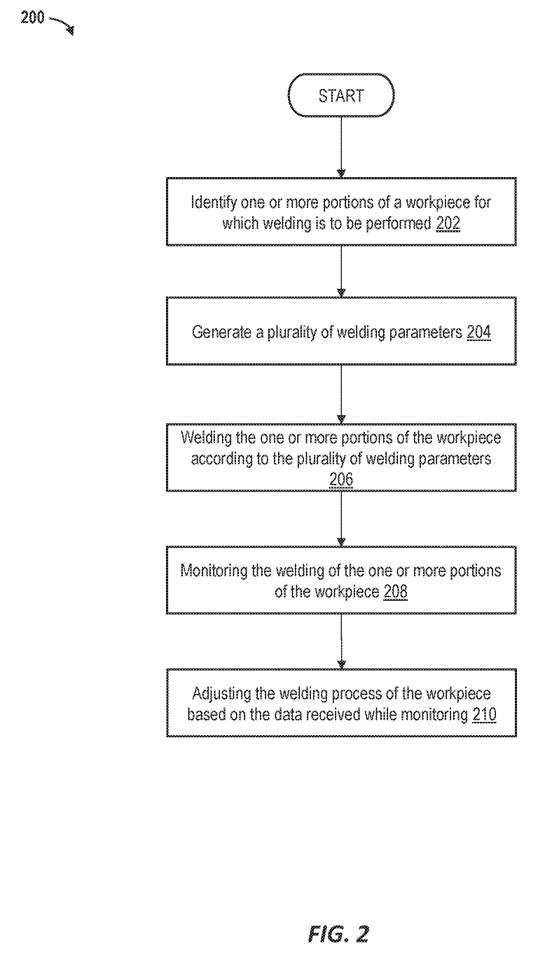

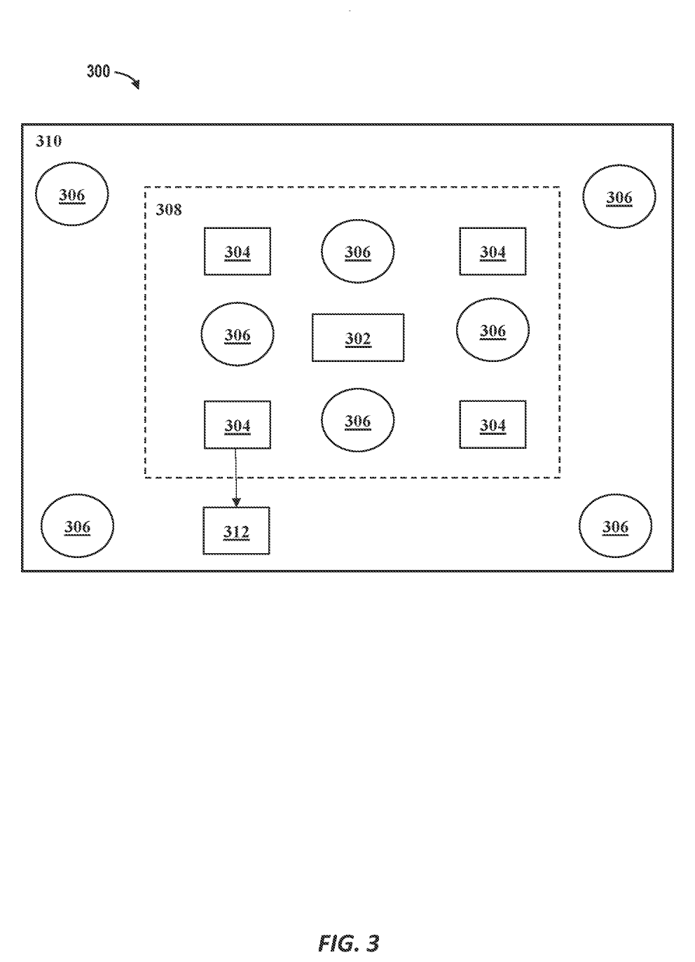

According to the present embodiment, the computer environment 100 may use the intelligent welding module 150 to manage magnetic properties during repair activities such that the intelligent welding module 150 evaluates the impact of welding on magnetic properties, simulates field changes, and dynamically positions secondary electromagnetic components and controls integrated heating and cooling systems throughout a welding process. The intelligent welding method is explained in more detail below with respect to FIGS. 2-3.

Referring now to FIG. 2, an operational flowchart illustrating the exemplary intelligent welding process 200 used by the intelligent welding module 150 according to at least one embodiment is depicted.

At 202, the intelligent welding module 150 identifies one or more portions of a workpiece for which welding is to be performed. The workpiece may be piece of equipment, tool, machine, and/or another component of an industrial floor. The industrial floor may be comprised of a plurality of machines, the workpiece for which welding is to be performed, a plurality of Internet of Things (IoT) devices and/or other multi-sensor data controllers/receivers, welding equipment, welding devices, heating and cooling equipment, environmental control equipment, secondary electromagnetic component deployment equipment, robotic systems, automated machines, non-automated machines, equipment controlled by a coordinated control system, motorized rails, a conveyor system, wiring, lighting, electronic forges, equipment that may generate a magnetic field, equipment that may be impacted by magnetic field changes, vehicles, transportation mechanisms, or any combination thereof that may be used in a manufacturing, fabrication, assembly, and/or other process that me performed on an industrial floor.

The intelligent welding module 150 may receive data for the industrial floor prior to the identifying of the one or more portions of the workpiece for which welding is to be performed. Data for the workpiece in which welding is to be performed and the data for the industrial floor may be received, identified, and/or uploaded by a user of the intelligent welding module 150 within an intelligent welding user interface (e.g., user interface). The intelligent welding module 150 may display the intelligent welding user interface (e.g., user interface) to the user in at least, an internet browser, dedicated software application, and/or as an integration with a third party software application. The intelligent welding user interface (e.g., user interface) may be part of the UI device set 123 and accessed by the user utilizing one or more of the EUDs 103. Additionally, the data may be received, identified, and/or uploaded directly by the user within the user interface and/or received from one or more cameras, scanners, and/or one or more other Internet of Things (IoT) devices within the IoT sensor set 125 that may be associated with the industrial floor and/or the workpiece for which welding is to be performed. The data received, identified, and/or uploaded from the user and/or the one or more IoT devices may be stored in a knowledge corpus (e.g., database 130). Furthermore, the workpiece and the one or more portions of the workpiece for which welding is to be performed may be identified directly by the user within the user interface and/or may be recognized automatically by the intelligent welding module 150.

The one or more cameras, scanners, and/or one or more IoT devices may also be controlled by the intelligent welding module 150. The user may identify and/or permit access and control for the one or more IoT devices and/or other sensors to the intelligent welding module 150 in the user interface. The one or more IoT devices associated with the physical industrial floor may include, but are not limited to including, thermostats, lighting, air quality, smoke detectors, carbon monoxide detectors, irrigations systems, security, air conditioning, movement, and ventilation systems, amongst other IoT devices. The one or more IoT devices may perform readings of the environment and/or control the environmental conditions within the industrial floor.

The IoT devices may be connected to one or more sensors (e.g., magnetic flux sensors, eddy current testers, temperature sensors, motion sensors, humidity sensors, pressure sensors, accelerometers, gas sensors, multi-purpose IoT sensors, permeability sensors, magnetic field sensors, amongst other sensors) to perform the one or more readings and/or control the environmental conditions. The data from the one or more readings performed by the IoT devices may be stored on the IoT device itself and/or broadcasted to the knowledge corpus (e.g., database 130). The intelligent welding module 150 may also receive images and/or 3D scans of assets comprising the physical ecosystem, such as, but not limited to, machines and/or equipment, amongst other assets. The intelligent welding module 150 may receive the images, videos, and/or 3D scans from an IoT device equipped with a camera. As will be described in more detail below, the intelligent welding module 150 may directly control the one or more IoT devices, multi-data sensors, coordinated control system, deployment mechanisms for secondary electromagnetic components, heating and cooling treatments, robotic systems designated by the user for use in the welding of the one or more portions of the workpiece, amongst other devices within/surrounding the industrial floor that may be controlled without human involvement.

The intelligent welding module 150 may direct the one or more IoT devices to perform specific environmental condition readings at specific frequencies and/or time intervals and/or direct the one or more IoT devices to perform a specific reading. The intelligent welding module 150 may direct the one or more IoT devices to gather data required for simulations and forecasting potential impacts on surrounding magnetic-sensitive equipment and may also utilize the one or more IoT devices and other devices to control the environment during the welding process of the workpiece.

Alternatively, the intelligent welding module 150 may utilize the one or more IoT devices, sensors, and/or other imaging technologies to map the workpiece and identify areas requiring repair. In some embodiments, the intelligent welding module 150 may continuously evaluate the industrial floor and proactively identify workpieces that may require welding. In this embodiment, the intelligent welding module 150 may identify the potential workpiece in the user interface and transmit a notification to the user for confirmation, including a detailed assessment with respect to how the workpiece was identified. Based on the user’s response confirming or denying the need for welding, the intelligent welding module 150 may be trained based on this feedback to identify a threshold by which the user should be notified. Areas requiring repair may be identified through visual inspection, non-destructive testing methods, or analysis of operational data. The intelligent welding module 150 may evaluate the potential impact of welding on these areas by considering factors such as the proximity to magnetic-sensitive equipment, the extent of the required repair, and the current magnetic properties of the area.

In addition, to the IoT devices and other data sources described above the intelligent welding module 150 may also utilize a plurality of magnetic field sensors. Magnetic property measurements may be taken before, during, and after welding using specific sensors. In some cases, gaussmeters or fluxgate magnetometers may be used to measure magnetic flux density in the workpiece. Eddy current testers may be employed to assess material permeability. These measurements may provide baseline data on the magnetic properties of the workpiece before any welding is performed. Prior to welding the intelligent welding module 150 may measure baseline magnetic properties of the workpiece and one or more surrounding machines, equipment, or structures using devices such as, but not limited to gaussmeters or fluxgate magnetometers for magnetic flux density and eddy current testers for material permeability. These devices and/or readings may be performed using the one or more IoT devices described above equipped with these sensors and/or a separate device. During welding the intelligent welding module 150 may utilize real-time IoT sensors positioned throughout the industrial floor and/or surrounding the repair area (e.g., area where the workpiece is being welded) to capture changes in the local magnetic field due to ferrite formation, for example, the intelligent welding module 150 may utilize one or more IoT devices equipped with hall-effect sensors to provide localized field intensity readings. Post-welding the intelligent welding module 150 may perform detailed scans using, for example, Magnetic Barkhausen Noise Analysis for stress-related permeability changes and/or non-destructive testing (NDT) with eddy current arrays.

The magnetic property measurements may be taken by the intelligent welding module before, during, and after welding using high-precision sensors. In some cases, Hall effect gaussmeters or fluxgate magnetometers with sensitivities in the nanotesla range may be used to measure magnetic flux density in the workpiece. Alternating current field measurement (ACFM) techniques may be employed to assess material permeability and detect surface-breaking defects. These measurements may provide baseline data on the magnetic properties of the workpiece before any welding is performed, with a resolution capable of detecting localized variations in magnetic field strength.

The data received, identified, and/or uploaded from the user may include details such as, but not limited to, a brand, model number, bill of materials, product codes, part numbers, design specifications, production processes, engineering information, material composition of parts, amongst other data for the machines and/or equipment of the industrial floor as well as the workpiece for which welding is to be performed. The user may also directly identify any magnetic field sensitive components of the machines, equipment, or workpiece utilized on the industrial floor and/or the intelligent welding module 150 may leverage information and/or data provided by the user in identifying any magnetic field sensitive components on the industrial floor. For example, the intelligent welding module 150 may leverage the bill of materials and material composition of various parts of each asset, machine, or piece of equipment of the industrial floor in conjunction with the a machine learning model utilizing various Natural Language Processing (NLP) techniques to identify additional information related to each asset, machine, or piece of equipment of the industrial floor, including, but not limited to including, magnetic field sensitive components. As will be explained in greater detail below, the data received, identified, and/or uploaded from the user, may be stored as information in the knowledge corpus (e.g., database 130) and utilized in generating a digital twin of the industrial floor. The machine learning model with NLP and associated linguistic analysis techniques and search methods utilized by the intelligent workflow module 150 will be explained in greater detail below.

The user may also separately identify any machines, tools, and/or equipment that may be utilized in the welding process. These machines, tools, and/or equipment may be on the industrial floor and/or separate from the industrial floor and may be designated by the user in the intelligent welding user interface (e.g., user interface) for welding of the one or more portions of the workpiece. These machines, tools, and/or equipment may include welding devices as well as other machines, tools, and/or equipment that may be required in welding the one or more portions of the workpiece. As will be explained in greater detail below, the intelligent workflow module 150 may include virtual representations of these machines, tools, and/or equipment in the digital twin of the industrial floor. These digital twins may correspond to the real world capabilities of these machines, tools, wiring, equipment, any other magnetic field generating device, or any combination thereof. Furthermore, the digital twins may include the characteristics, properties, parameters, composition, dimensions, or anything other information about the workpiece. The workpiece will be described in further details below. The digital twins enables the intelligent workflow module 150 to simulate different combinations of the designated machines, tools, and/or equipment such that business processes are minimally disrupted, and the simulations reflect the actual capabilities of these machines, tools, and/or equipment.

In some embodiments, the intelligent workflow module 150 may also be capable of receiving a digital model of the structure directly from the user in one or more different file formats, including, but not limited to, Virtual Reality Modeling Language (VRML), OBJ file format, Polygon File Format (PLY), G-code format, amongst other formats. The data received directly from one or more cameras, scanners, and/or one or more Internet of Things (IoT) devices associated with the structure to be dismantled may include, but not limited to, laser scans, LIDAR scans, 3D scans, photogrammetry information extracted from images or videos utilizing photogrammetry software, amongst other means of high-resolution data capture.

The data received, identified, and/or uploaded by the user may also include information relating to one or more business process, activities, repairs, tasks, advanced manufacturing, and/or other processes performed on the industrial floor. The data may include Key Performance Indicators (KPIs) for all assets of the industrial floor including the workpiece to be welded, throughput and production numbers for the industrial floor, efficiency metrics, readings or historical data recorded by the plurality of machines and/or equipment, amongst other productivity metrics. As will be explained in more detail below, this data and/or information may be utilized to at least enhance the digital twins generated for each of the assets, machines, or pieces of equipment of the industrial floor such that the capabilities of those assets, machines, or pieces of equipment correspond to the virtual representation. This data and/or information may additionally be leveraged by the intelligent welding module 150 in at least monitoring changes in the KPIs and other productivity metrics before, during, and after the welding process such that relationships between changes in magnetic properties and operational performance changes may be identified. This information may also be directly and automatically received from one or more IoT devices associated with the industrial floor, IoT devices associated with the machines of the industrial floor, and/or internal databases utilized by the user for tracking the processes performed on the industrial floor. Additionally, the data received, identified, and/or uploaded by the user may also include information and/or data relating to the machines, tools, and/or equipment that may be utilized in the welding process. These machines, tools, and/or equipment that may be utilized in the welding process may be specifically designated by the user in the user interface. The welding equipment which may be designated by the user may include welding devices, such as, welding torches, welding machines, wire feed welders, gas metal arc welding (GMAW) welding machines, metal inert gas (MIG) welding machines, metal active gas (MAG) welding machines, tungsten inert gas (TIG) welders, AC/DC welders, dual voltage welders, gas tungsten arc welding (GTAW) welders, flux-corded arc welding (FCAW) machines, plasma arc welding machines, atomic hydrogen welding machines, laser beam welding machines, resistance welding machines, oxyfuel welding machines, electroslag welding machines, fillet welding machines, stick welding machines, amongst other welding devices. The welding equipment may also include other equipment, which may include but is not limited to including, angle grinders, chipping hammers, wire brushes, metal files, metal brushes, welding clams, welding magnets, transportation machines, clamping machines, welding safety equipment, amongst other equipment which may be utilized in welding.

The process of identifying and evaluating portions of a workpiece for welding by the intelligent workflow module 150 may involve several steps to assess the potential impact on magnetic properties and operational criticality. In some cases, advanced non-destructive testing (NDT) techniques may be employed to map the workpiece and identify areas requiring repair. These techniques may include phased array ultrasonic testing (PAUT) for detecting subsurface flaws, eddy current array (ECA) for surface and near-surface defect detection, and digital radiography for comprehensive internal inspection.

As will be explained in more detail below, this information and data stored in the knowledge corpus (e.g., database 130) may be utilized in creating digital models, 3D models, digital twins, and/or other virtual representations of at least the industrial floor, the workpiece, and/or the portions of the workpiece for which welding is to be performed. All of the data received before welding, during welding, and post-welding may be stored in the knowledge corpus (e.g., database 130) and utilized to retrain the one or more machine learning models and improve the trial and error simulations. The knowledge corpus (e.g., database 130) may include information about each piece of machine, equipment, tool, welding device, and/or anything else comprising the industrial floor. The information may include the data provided by the user, received or gathered from the IoT devices, and/or other data, such as the alloys comprising each machine, equipment, or tool, there specific properties, such as melting point and/or material compositions, as well as environmental conditions the machine, equipment, or tools are operated in. All of this information stored in the knowledge corpus (e.g., database 130) may be embedded in the digital twin.

In at least one embodiment, the intelligent welding module 150 may create a high-fidelity 3D model and/or digital twin of the activity area/repair area, including the workpiece and surrounding magnetic-sensitive equipment, using laser scanning technology or photogrammetry. This model may be integrated with finite element analysis (FEA) software to simulate the effects of welding on magnetic properties and identify optimal positioning for secondary electromagnetic components. In some cases, the 3D model may incorporate data from multiple sensors to provide a comprehensive view of the workpiece's magnetic landscape, allowing for real-time visualization of magnetic field distributions.

The intelligent welding module 150 may generate a digital twin (e.g., three-dimensional (3D) model) of the industrial floor based on at least the data described above which is stored in the knowledge corpus (e.g., database 130). The digital twin may include, but is not limited to including, a virtual representation of the workpiece, the welding devices, the equipment/machines/assets, of the industrial floor, industrial floor itself, including a layout and positioning of all equipment/machines/assets, and virtual representations that reflect the real world capabilities of any welding tools/equipment which may be utilized in the welding process. The digital twin may be a virtual representation of an object or system that spans the object or system’s lifecycle, may be updated using real-time data, and may utilize at least, simulation, machine learning, and/or reasoning in aiding informed decision making. Accordingly, the digital twin may be a real time virtual representation of the industrial floor in which the workpiece and other machines/equipment are digitally represented and include the characteristics and/or properties of the real world physical asset. The intelligent workflow module 150 may enable the user to interact and/or modify the digital twin within the intelligent welding user interface (e.g. user interface). In these embodiments, the EUD 103 may be an Augmented Reality (AR) and/or Virtual Reality (VR) enabled device that may enable the user manipulate the digital twin and/or enable the intelligent workflow module 150 to overlay information associated with the digital twin to the user, which the user may interact with, such as, but not limited to, input parameters for trial-and-error simulations, projected Key Performance Indicators (KPIs) for the workpiece before and after welding, information or data to be confirmed by the user, amongst other information which may be presented to the user.

These digital twins (e.g., 3D models) may also include the machines, tools, and/or equipment that may be utilized in the welding process. These digital twins may correspond to the real world capabilities of these machines, tools, and/or equipment and may enable the intelligent workflow module 150 to simulate different combinations of the designated machines, tools, and/or equipment such that business processes are minimally disrupted, and the simulations reflect the actual capabilities of these machines, tools, and/or equipment which will be utilized in performing the welding. The intelligent welding module 150 may create a 3D model (e.g., digital twin) of the activity area, including the workpiece and surrounding magnetic-sensitive equipment. This model may be used to simulate the effects of welding on magnetic properties and identify optimal positioning for secondary electromagnetic components. In some cases, the 3D model may incorporate data from multiple sensors to provide a comprehensive view of the workpiece's magnetic landscape.

As will be explained in more detail below, the intelligent welding module 150 may leverage the digital twin to be updated in real time based on sensor data such that the area surrounding the workpiece may capture changes in the local magnetic field due to ferrite formation in real time. Additionally, the digital twin may be utilized by the intelligent welding module 150 in providing the geometry of the workpiece as well as the positioning of assets, structures, machines, equipment, and/or components of the industrial floor in real time. Furthermore, as will be explained in more detail at step 204, the digital twin may enable the intelligent welding module 150 to perform a series of trial-and-error simulations with different input parameters, such that the parameters may be optimized specifically to the workpiece and the surrounding structures of the industrial floor.

The digital twin and/or 3D model of the workpiece and the industrial floor may also integrate historical data stored in the knowledge corpus (e.g., database 130). The historical data may be utilized in training one or more machine learning models utilized by the intelligent welding module. The one or more machine learning models may include, but are not limited to including, one or more neural networks which may be utilized by the intelligent welding module 150 to create an Artificial Intelligence (AI) model from the historical data. The intelligent welding module 150 may utilize the data and information received with respect to the workpiece to be welded and the machine, equipment, and/or other components of the industrial floor in retrieving relevant historical data. The intelligent welding module 150 may utilize a machine learning model utilizing various Natural Language Processing (NLP) techniques, such as those implemented in IBM Watson® (IBM Watson® and all Watson-based trademarks are trademarks or registered trademarks of International Business Machines Corporation in the United States, and/or other countries), to perform at least keyword extraction and/or classification techniques to identify data related to different types of welding. The historical data related to different types of welding may include, but is not limited to including, welding parameters, changes in microstructure, post-welding magnetic property changes, heat treatment specifications, empirical relationships, and/or phase diagrams related to the material compositions and/or magnetic properties of the workpiece for which welding is to be performed and/or the material compositions and/or magnetic properties of the equipment, machines, and/or their components on the industrial floor.

The historical data identified by the intelligent welding module may be derived from previously performed welds by the intelligent welding module 150, datasets provided by the user, and/or publicly available data. The welding parameters may include, but are not limited to including, welding speed, heat input, filler material, amongst other welding parameters. The changes in microstructure may include, but are not limited to including, grain size, phase composition, amongst other changes in microstructure. The post-welding magnetic property changes may include, but are not limited to including, magnetic permeability, remanence, amongst other post-welding magnetic property changes. The heat treatment specifications may include, but are not limited to including, temperature profiles, cooling rates, amongst other heat treatment specifications. The empirical relationships and/or phase diagrams, may include, but are not limited to including, Schaeffler diagrams, Delong diagrams, and/or other empirical relationships and/or phase diagrams which may be utilized to estimate the ferrite content introduced during welding based on material composition and cooling rates. As will be explained in greater detail below, ferrite fraction may affect magnetic permeability, which may be calculated using material-specific equations. For example, based on the historical learning the intelligent welding module 150 may be able to identify how much magnetic leakage may happen from the workpiece and a projected impact of this leakage on the workflow of the industrial floor based on historical data identified for similar workpieces of similar compositions. The intelligent workflow module 150 may utilize standard reference samples with known ferrite content and magnetic properties for calibration, such that the simulation models may be validated against experimental data to further ensure accuracy.

As will be described in greater detail below, the intelligent welding module 150 may use the historical data and one or more machine learning algorithms to predict how welding in specific areas might affect the overall magnetic properties of the workpiece. This predictive capability may help in assessing the operational criticality of changes in magnetic properties for different portions of the workpiece. The evaluation process may also consider the feasibility of using secondary electromagnetic components to counteract any undesired changes in magnetic properties during welding. The intelligent welding module 150 may simulate various configurations of these components to determine their effectiveness in maintaining the desired magnetic properties of the workpiece. By combining IoT sensor data, user input data, digital twin and/or 3D modeling, historical learning, and predictive analysis, the intelligent welding module 150 may provide a comprehensive assessment of which portions of the workpiece are suitable for welding, taking into account both the necessary repairs and the potential impact on magnetic properties.

At 204, the intelligent welding module 150 generates a plurality of welding parameters. The intelligent welding module 150 may generate the plurality of welding parameters based on historical learning and a plurality of simulations. The plurality of simulations may include, but are not limited to including, trial-and-error simulations, and/or one or more machine learning models/simulation models/deep learning models. The trial-and-error simulations and/or one or more machine learning models/ simulation models/deep learning models using at least the historical data and/or other data/information stored in the knowledge corpus (e.g., database 130), as described in detail at step 202, as input data for the simulations. The intelligent workflow module 150 may utilize historical data retrieved from the knowledge corpus (e.g., database 130) including, for example, standard reference samples with known ferrite content and magnetic properties for calibration, such that the trial-and-error simulations and/or simulation models may be validated against experimental data to further ensure accuracy.

As will be explained in more detail below, the one or more machine learning models may be trained by the intelligent welding module 150 using, for example, at least one or more of, historical welding data (e.g., historical data), magnetic property data, standard reference samples with known ferrite content, magnetic property data, amongst other data. Additionally, the one or more machine learning models may receive input including, but not limited to including, magnetic field-sensitive components of the workpiece and surroundings, environmental conditions from the one or more IoT devices, material properties and compositions of the workpiece, specifications of the equipment and tools involved in the welding process, real-time data and magnetic field measurements. The simulations performed by the one or more machine learning models may be validated against experimental data to ensure accuracy of the plurality of welding parameters. Additionally, the one or more machine learning models may utilize input from trial-and-error simulations and updates based on real-time data during the welding process to adjust and/or modify the plurality of welding parameters.

The intelligent welding module 150 may analyze the historical data, including at least past welding data, to identify patterns and correlations between various factors that influence magnetic properties and ferrite formation. For example, the intelligent welding module 150 may consider at least material properties, environmental conditions, and specific repair requirements when generating welding parameters. The one or more machine learning models (e.g., simulation models, deep learning models) may be trained on historical welding and magnetic property datasets to predict resultant magnetic fields. As will be explained in more detail below, the intelligent welding module 150 may use the one or more machine learning models (e.g., simulation models, deep learning models) to simulate different welding scenarios and predict their outcomes before actual welding begins. This predictive analysis may allow for fine-tuning of welding parameters to achieve desired magnetic properties and minimize unwanted ferrite formation. The intelligent welding module 150 may continuously update and refine the one or more machine learning models (e.g., simulation models, deep learning models) as new welding data becomes available and is added to the knowledge corpus (e.g., database 130). This continuous learning process may enable the intelligent welding module 150 to improve its predictive accuracy and adapt to new materials, repair scenarios, or environmental conditions over time.

The intelligent welding module 150 may utilize a plurality of welding parameters as input for the trial-and-error simulations and/or simulation models (e.g., machine learning models, deep learning models). The intelligent welding module 150 may vary the plurality of welding parameters according to the historical data such as, but not limited to, geometry of the workpiece, measured or predicted ferrite distributions, external magnetic fields interacting with the industrial floor and/or area surrounding the welding process, amongst other input parameters. The intelligent welding module 150 may also utilize time-dependent thermal gradients during welding in the simulation to predict transient magnetic field changes. The intelligent welding module 150 may also perform these trial-and-error simulations and/or simulations utilizing the digital twin of the industrial floor generated at step 202. The trial-and-error simulations and/or simulation models (e.g., machine learning models, deep learning models) may also identify deviation thresholds in which the parameters of the welding process are allowed to vary without impacting the end result, as will be explained at step 206, the coordinated control system may be utilized in maintaining these parameters within the designated range. For example, the one or more machine learning models may simulate different welding scenarios using historical data, material compositions, and environmental conditions to predict outcomes. Parameters such as heat input and cooling rates may be optimized through these simulations, including finite element analysis and deep learning models, to ensure a desired microstructure and ferrite control based on the plurality of welding parameters generated. Furthermore, the intelligent welding module 150 may utilize the one or more machine learning models in predicting post-welding magnetic property changes by combining the historical data, simulation outputs, and measurements from the one or more IoT devices, magnetic flux sensors, and eddy correct testers. The intelligent welding module 150 utilizes the one or more machine learning models to assess at least magnetic permeability, remanence, and microstructural changes to anticipate the magnetic property shifts.

Additionally, the plurality of welding parameters may also consider the capabilities of the equipment to be utilized in the welding process. The digital twin of the industrial floor generated at step 202 may reflect the real-world capabilities of these machines such that the input utilized by the one or more machine learning models (e.g., simulation models, deep learning models) may consider different combinations of the tools, equipment, and/or machines designated by the user for the welding process at step 202. The one or more machine learning models (e.g., simulation models, deep learning models) may not only consider the capabilities of these designated assets but may also consider the processes being performed on the industrial floor, such that the plurality of welding parameters may not just consider the most capable machines or equipment but also the downtime of other operations or processes being performed on the industrial floor. The plurality of welding parameters may also include instructions as to how the industrial floor may be rearranged to enable the continuous operation of magnetic sensitive areas and/or avoid potential adverse effects to magnetic sensitive equipment of the industrial floor. For example, the intelligent welding module 150 may determine based on the magnetic property measurements performed at step 202 that Machine A may be adversely impacted if the welding process of the workpiece was to be performed in its current location on the industrial floor. In this example, the intelligent welding module 150 may include in the plurality of welding parameters to either move the workpiece or Machine A prior to initiating the welding process. In some embodiments, the intelligent welding module 150 may utilize automated machines or robots to directly move the workpiece or Machine A and/or utilize the automative capabilities of Machine A or the workpiece to reposition within the industrial floor. The repositioning being designed to eliminate any effect of magnetic field leakage from the weld area to any magnetic sensitive assets of the industrial floor.

The one or more machine learning models (e.g., simulation models, deep learning models) utilized by the intelligent welding module 150 may include at least Finite Element Method (FEM) based electromagnetic simulations, Monte Carlo simulation processes, convolutional neural networks (CNNs), and/or long short-term memory (LSTM) networks amongst other processes and models. The FEM-based electromagnetic simulations may be performed using a third-party simulation software package and/or be performed by the intelligent welding module 150 in the user interface. The intelligent welding module 150 may additionally utilize a statistical program such as IBM’s SPSS® (SPSS® and all SPSS-based are trademarks or registered trademarks of International Business Machines Corporation in the United States, and/or other countries), or Statistical Product and Service Solution, in optimizing the simulation processes and/or simulation models. For example, the intelligent welding module 150 may use the historical data and deep learning models described above to predict how welding in specific areas might affect the overall magnetic properties of the workpiece. These models may be trained on extensive datasets of previous welding operations, incorporating variables such as material composition, welding parameters, and environmental conditions. This predictive capability may help in assessing the operational criticality of changes in magnetic properties for different portions of the workpiece with a high degree of accuracy.

The intelligent welding module 150 may also direct the one or more IoT devices to gather additional data for the one or more machine learning models and/or trial-and-error simulations. For example, the intelligent welding module 150 may direct an IoT device closest to the workpiece to perform a temperature reading for input into the machine learning model and/or direct an IoT device equipped with a camera to capture additional images of the workpiece and/or one or more specific portions of the workpiece prior to performing the trial-and-error simulations.

The trial-and-error simulations may be visual simulations viewable by the user within the intelligent welding user interface (e.g., user interface). The series of trial-and-error simulations may be performed according to various sets of a plurality of parameters, such as, but not limited to, speed, temperature, penetration, amongst other parameters which may be modified and/or adjusted based on the data stored in the knowledge corpus (e.g., database), simulated outcomes of the trial-and-error simulations, and/or input from the user in the intelligent welding user interface (e.g., user interface). In at least one embodiment, the intelligent welding module 150 may utilize the trial-and-error simulations to consider the feasibility of using secondary electromagnetic components to counteract any undesired changes in magnetic properties during welding. The intelligent welding module 150 may simulate various configurations of these components using electromagnetic field simulation software, considering factors such as coil geometry, current density, and magnetic field strength. These simulations may help determine the most effective arrangement of electromagnetic components to maintain the desired magnetic properties of the workpiece throughout the welding process which may be utilized as input parameters for the welding process. If the intelligent welding module 150 is able to utilize the secondary electromagnetic particles/shields, then the welding process at 206 may be initiated without downtime. If the intelligent welding module is unable to utilize the secondary electromagnetic particles/shiels, then the welding process may include repositioning machines and/or equipment and/or required downtime for the welding activity and post-heat treatment activity.

Utilizing historical learning and the AI-driven analysis described in detail above, the intelligent welding module 150 may generate welding parameters that are tailored to the specific workpiece and repair requirements. This approach may help ensure optimal magnetic property management and ferrite formation control during welding operations. Furthermore, by leveraging these predictive capabilities, the intelligent welding module 150 may adapt welding parameters in real-time to optimize magnetic property management and ferrite formation control by providing real-time data input from the welding process to the one or more machine learning models (e.g., simulation models, deep learning models) described above.

At 206, the intelligent welding module 150 welds the one or more portions of the workpiece. The intelligent welding module 150 may weld the one or more portions of the workpiece according to the plurality of welding parameters generated at step 204. The intelligent welding module 150 may perform the welding utilizing one or more of the plurality of machines, equipment, assets, designated by the user at step 202, which may include at least one or more welding devices.

The welding equipment which may be designated by the user may include welding devices, such as, welding torches, welding machines, wire feed welders, gas metal arc welding (GMAW) welding machines, metal inert gas (MIG) welding machines, metal active gas (MAG) welding machines, tungsten inert gas (TIG) welders, AC/DC welders, dual voltage welders, gas tungsten arc welding (GTAW) welders, flux-corded arc welding (FCAW) machines, plasma arc welding machines, atomic hydrogen welding machines, laser beam welding machines, resistance welding machines, oxyfuel welding machines, electroslag welding machines, fillet welding machines, stick welding machines, amongst other welding devices. The welding equipment may also include other equipment, which may include but is not limited to including, angle grinders, chipping hammers, wire brushes, metal files, metal brushes, welding clams, welding magnets, transportation machines, clamping machines, welding safety equipment, amongst other equipment which may be utilized in welding.

The intelligent welding module 150 may utilize a coordinated control system in welding the one or more portions of the workpiece. The coordinated control system may include, but is not limited to including, controlling one or more pieces of equipment being utilized in the welding process, automated welding machines, machines utilized in positioning, clamping, or stabilizing the workpiece as it is being welded, heating and cooling systems, equipment for deploying and dynamically positioning secondary electromagnetic components for shielding and pre-emptive protection.

The intelligent welding module 150 may generate instructions for one or more welding machines and/or machines utilized in positioning, clamping, or stabilizing the workpiece based on the input parameters determined at step 204. The welding machines and/or other machines/equipment utilized by the intelligent welding module 150 may be comprised of entirely automated machinery, a combination of both automated and non-automated machinery, or entirely non-automated machinery. The intelligent workflow module 150 may support a plurality of robotic controllers enabling the export of programs to automated machines within the designated welding machines. Depending on the level of automation capabilities of the designated welding machines the welding process may be implemented in the real world with or without human involvement.

The instructions and the plurality of welding parameters may be transmitted to the one or more of machines and/or equipment designated for the welding process by the user at step 202 based the machines and/or equipment identified by the one or more machine learning models (e.g., simulation models, deep learning models) at step 204. These instructions may correspond to the real world capabilities of the machines, tools, and/or equipment because of the digital twin utilized by the intelligent welding module 150. The instructions and the plurality of welding parameters may include pre-weld instructions, such as the repositioning of the workpiece, magnetically sensitive machines, and/or the deployment of secondary electromagnetic materials for shielding purposed. The intelligent workflow module 150 may utilize supported robotic controllers in controlling the automated machines directly and/or may provide instructions directly to human operators and/or the user within the intelligent welding user interface (e.g., user interface) utilizing an interactive AR/VR environment presented on the EUD 103 based on the digital twin of the industrial floor. As will be explained in more detail below, the coordinated control system may be utilized by the intelligent welding module 150 in not only monitoring the various parameters during the welding process but also controlling those parameters such that are maintained within deviation thresholds identified in the trial-and-error and/or other simulations.

The coordinated control system may continuously monitor various parameters during the welding process, including temperature, cooling rate, and magnetic field strength. In some cases, this real-time data may be compared against the simulated predictions to ensure that the welding process is proceeding as expected. If deviations are detected, the intelligent welding module 150 may automatically adjust welding parameters, cooling rates, or heat treatments to maintain optimal conditions for ferrite formation control and magnetic property management. In automated systems, the intelligent welding module 150 may directly maintain these conditions. In systems that require human involvement, the intelligent workflow module 150 may provide detailed adjustment instructions to the user in the intelligent welding user interface (e.g., user interface). These detailed adjustment instructions to the user may be generated using the one or more machine learning models (e.g., simulation models, deep learning models) and be provided within a VR and/or AR environment presented to the user on the EUD 103.

The heating and cooling modules utilized in implementing the heating and cooling treatments of the coordinated control system may be implemented by the intelligent welding module 150 using a variety of methods and technologies. In some cases, induction heating systems may be used for localized and precise heat application. These systems may allow for rapid heating of specific areas of the workpiece, enabling controlled thermal gradients and targeted microstructure modifications. The induction heating parameters, such as frequency and power output, may be dynamically adjusted based on real-time feedback from temperature sensors and magnetic field measurements. Additionally, cryogenic cooling systems may be integrated into the welding process for rapid and controlled temperature reduction. In some cases, liquid nitrogen or helium may be used as coolants, delivered through specially designed nozzles or cooling jackets. The flow rate and distribution of the cryogenic coolant may be precisely controlled to achieve desired cooling rates and temperature profiles across the workpiece. This rapid cooling capability may be particularly useful for controlling ferrite formation and preserving desired magnetic properties in certain alloy systems. The intelligent welding module 150 may also incorporate pulsed laser heating for highly localized and transient heat treatments. In some cases, this technique may be used to modify the microstructure of specific regions within the weld or heat-affected zone. The laser parameters, including pulse duration, energy density, and spot size, may be adjusted in real-time based on feedback from thermal imaging cameras and magnetic sensors. The intelligent welding module 150 may also utilize resistance heating elements which may be embedded in or placed around the workpiece to provide controlled background heating or to maintain specific temperature gradients. In some cases, these heating elements may be segmented and individually controlled to create complex thermal profiles across the workpiece. This approach may allow for precise management of cooling rates and post-weld heat treatments.

In some embodiments, the intelligent welding module 150 may utilize advanced thermal management materials, such as phase change materials or heat pipes, to assist in controlling heat flow and temperature distribution. In some cases, these materials may be integrated into fixtures or tooling used during the welding process, helping to stabilize temperatures and reduce thermal gradients in critical areas. Additionally, electromagnetic stirring techniques may be employed during the welding process to influence heat and mass transfer within the weld pool. In some cases, this may help control the distribution of alloying elements and modify the solidification behavior, potentially influencing ferrite formation and magnetic properties. The frequency and intensity of the electromagnetic stirring may be dynamically adjusted based on real-time monitoring of the weld pool and surrounding magnetic field.

The coordinated control system may implement adaptive heating and cooling strategies based on the specific requirements of different regions within the workpiece. In some cases, this may involve simultaneous heating and cooling of adjacent areas to create desired thermal gradients or to manage residual stresses. The intelligent welding module 150 may use the one or more machine learning models (e.g., simulation models, deep learning models) described in detail at step 204 to anticipate the thermal response of the workpiece and proactively adjust heating and cooling parameters to maintain optimal conditions throughout the welding process. For example, the welding process may generate significant heat. This heat generation may result in the temperature of the welding area moving towards an upper range of the temperature deviation thresholds identified by the one or more simulation models (e.g., machine learning models, deep learning models) at step 204. In this example, the intelligent welding module 150 may utilize one or more of the cooling strategies identified above to keep the temperature within the deviation thresholds. This may enable the intelligent welding module 150, to avoid changes to the microstructure of a base material in the heat-affected zone which could have led to changes in magnetic permeability and remanence which potentially could increase magnetic field leakage.

At 208, the intelligent welding module 150 monitors the welding of the one or more portions of the workpiece. The intelligent welding module 150 may utilize the one or more IoT devices and/or multiple other sensor feeds described in step 202 in monitoring the welding of the one or more portions of the workpiece. As will be explained in more detail below, the intelligent welding module 150 may monitor the implementation of the plurality of parameters and compare the welding performance to the simulated and/or projected welding process of the one or more machine learning models (e.g., simulation models, deep learning models).

The intelligent welding module 150 may incorporate a comprehensive real-time monitoring setup that utilizes multiple sensor feeds to continuously assess the welding process and its effects on magnetic properties. In some cases, these sensor feeds may include magnetic field sensors, temperature sensors, and material composition analyzers strategically positioned around throughout the industrial floor and/or the welding area.

The magnetic field sensors may be used to detect changes in the local magnetic field during welding. In some cases, these sensors may include Hall effect sensors or fluxgate magnetometers capable of providing high-resolution measurements of magnetic flux density. The intelligent welding module 150 may analyze the data from these sensors to identify any unexpected changes in magnetic properties that could indicate ferrite formation or other undesirable effects. The intelligent welding module 150 may identify the unexpected changes based on the predicted simulation readings performed by the one or more machine learning models (e.g., simulation models, deep learning models) described in detail at step 204 and/or a comparison of the sensor data with the historical data and other information stored in the knowledge corpus (e.g., database 130). The temperature sensors may be employed to monitor thermal gradients and cooling rates across the workpiece. In some cases, these may include thermocouples, infrared cameras, or fiber optic temperature sensors capable of providing precise temperature measurements in real-time. The temperature data may be utilized by the intelligent welding module 150 to ensure that cooling and heating treatments are applied effectively and that optimal conditions for controlling ferrite formation are maintained. The material composition analyzers may be utilized to detect changes in the chemical makeup of the weld area during the welding process. In some cases, these analyzers may use techniques such as X-ray fluorescence or laser-induced breakdown spectroscopy to provide real-time data on elemental composition. This information may be crucial for identifying potential issues related to ferrite formation or changes in magnetic properties due to compositional variations.

The intelligent welding module 150 may utilize one or more of the multiple sensor feeds, additional sensor feeds, and/or various combinations of sensor feeds in conjunction with the knowledge corpus (e.g., database 130) which contains historical welding data, material properties, and known relationships between welding parameters and magnetic properties, such that the intelligent welding module 150 may utilize the one or more machine learning models (e.g., simulation models, deep learning models) to evaluate predictive scenarios in real time during the welding process.

The intelligent welding module 150 may also analyze magnetic field line distribution to assess how ferrite introduction affects magnetic shielding effectiveness. This analysis may involve comparing the measured magnetic field patterns with predicted distributions based on the knowledge corpus and the simulation/predicted output of the one or more machine learning models (e.g., simulation models, deep learning models). By identifying deviations from expected patterns, the system may anticipate potential issues with magnetic shielding and implement corrective actions.

The intelligent welding module 150 may also monitor ferrite formation in real-time through analysis of sensor data and comparison with predictive models. As will be described in detail at step 210, when ferrite formation is detected, the intelligent welding module 150 may implement corrective actions by directly controlling welding equipment, cooling systems, and heating treatments. For example, the intelligent welding module 150 may utilize the coordinated control system to adjust welding parameters such as heat input or travel speed to minimize ferrite formation. Cooling rates may be modified by adjusting the flow of coolant or the intensity of cryogenic cooling systems. Heating treatments may be fine-tuned by altering the power output of induction heating systems or adjusting the parameters of pulsed laser treatments.

The intelligent welding module 150 may also directly control the one or more IoT devices, multi-data sensors, coordinated control system, deployment mechanisms for secondary electromagnetic components, heating and cooling treatments, robotic systems designated by the user for use in the welding of the one or more portions of the workpiece, amongst other devices within/surrounding the industrial floor that may be controlled without human involvement. The intelligent welding module 150 may utilize the devices and systems above in controlling how the welding process is monitored. For example, the intelligent welding module 150 may direct the one or more IoT devices to perform specific environmental condition readings at specific frequencies and/or time intervals and/or direct the one or more IoT devices to perform a specific reading. The intelligent welding module 150 may direct the one or more IoT devices to gather data required for continued simulations and forecasting potential impacts on surrounding magnetic-sensitive equipment based on real time data gathered during the monitoring of the welding process.

At 210, the intelligent welding module 150 adjusts the welding process of the one or more portions of the workpiece. The intelligent welding module 150 may adjust the welding process based on the monitoring of the real-time data using the multiple sensor feeds described at step 208. By continuously monitoring multiple sensor feeds, analyzing data in real-time, and implementing predictive scenario evaluation, the intelligent welding module 150 may anticipate and adjust the welding process, including the welding parameters in real-time. Additionally, the intelligent welding module 150 may adjust the welding process utilizing the one or more tools of the coordinated control system. In addition to controlling the equipment, the intelligent welding module 150 may notify users through the user interface (e.g., intelligent welding user interface) that corrective action has been taken. This notification may include details about the detected issue, the implemented corrective measures, and any recommendations for further action or monitoring.

The intelligent welding module 150 may perform controlled temperature treatments using either cooling or heating based on previously evaluated predictive scenarios. These treatments may be adjusted in real-time such that the treatments tailored to optimize weld quality, magnetic properties, and corrosion resistance. The intelligent welding module 150 may utilize one or more or a combination of the cooling and heating techniques described above to achieve a desired outcome. For example, for cooling treatments, the intelligent welding module 150 may employ cryogenic cooling methods using liquid nitrogen or helium. The cooling rate and duration may be precisely controlled based on real-time temperature measurements and predictive models. The system may adjust the flow rate and distribution of coolant to achieve optimal cooling profiles across the welded area. In another example, for heating treatments, the intelligent welding module 150 may utilize induction heating systems and/or resistance heating elements such that the intelligent welding module 150 may apply localized heating to specific regions of the weld to control microstructure development and manage residual stresses. The heating parameters, such as temperature ramp rates and hold times, may be dynamically adjusted based on feedback from temperature sensors and magnetic property measurements.

Post-weld heating and cooling treatments may be important in final welding process adjustments. For example, the intelligent welding module 150 may implement a series of heating and cooling cycles to refine the microstructure and optimize magnetic properties. These treatments may be designed to dissolve unwanted phases, promote grain refinement, or relieve internal stresses introduced during the welding process. The intelligent welding module 150 may verify the effectiveness of these treatments through non-destructive testing methods. In some cases, Magnetic Barkhausen Noise Analysis may be employed to assess stress-related permeability changes in post-welding evaluation. This technique may provide insights into the residual stress state and microstructural changes resulting from the welding and heat treatment processes.

The intelligent welding module 150 may also manage secondary shielding of other equipment in response to detected changes in magnetic properties. In some cases, this may involve activating or repositioning electromagnetic shielding components to counteract unwanted magnetic fields. The positioning and strength of these secondary shielding elements may be dynamically adjusted based on real-time sensor data and predictive output of the one or more machine learning models (e.g., simulation models, deep learning models) to maintain optimal protection for sensitive equipment in the vicinity of the welding operation within the industrial floor.

By continuously monitoring multiple sensor feeds, analyzing data in real-time, and implementing predictive scenario evaluation, the intelligent welding module 150 may anticipate and address potential issues related to magnetic properties and ferrite formation throughout the welding process. This approach may allow for precise control of the welding operation and associated treatments, ensuring that the desired magnetic properties are maintained in the repaired area while protecting surrounding sensitive equipment.

All data from the welding process including the adjustments made to the welding process may be stored in the knowledge corpus (e.g., database 130). This data may be utilized by the intelligent welding module 150 to improve future welds, by at least improving the predictive accuracy of the one or more machine learning models (e.g., simulation models, deep learning models), improving initial welding parameters, identifying issues such as ferrite formation earlier in future welds, amongst other improvements. The intelligent welding module 150 may continuously update its predictive capabilities based on new data, allowing for more accurate simulations and optimized welding strategies. This continuous learning process may enable the system to adapt to new materials, welding scenarios, or environmental conditions, improving its performance over time.

A detailed summary of the welding process and monitored data may be presented to a user through the user interface (e.g., intelligent welding user interface). In some cases, this summary may include information on ferrite formation and any methods used during the process to prevent ferrite formation. The user interface may provide visualizations of temperature profiles, magnetic property changes, and microstructural evolution throughout the welding and heat treatment processes. The intelligent welding module 150 may also identify how other magnetic sensitive components of the industrial floor were protected, before and after weld KPI comparisons, estimated avoided downtime, amongst other metrics. The intelligent welding module 150 may also provide a replay to the user of the welding process using the digital twin. This replay may be presented in a VR/AR environment on the EUD 103 and allow the user to interact with the replay. The user may pause, rewind, control the speed of the replay and also request additional information utilizing swipes, clicks, or other interactions within the environment. The intelligent welding module 150 may be able to pull user requested data directly from the knowledge corpus (e.g., database 130).

Referring now to FIG. 3, an exemplary industrial floor environment 300 used by the intelligent welding process 200 according to at least one embodiment is depicted.

The exemplary industrial floor environment 300 depicted in FIG. 3 may include, but is not limited to including, the workpiece 302 for which the welding is to be performed by the intelligent welding module 150, the machines or equipment 304 within the magnetically sensitive repair area 308 of the industrial floor and the industrial floor area 310. The devices 306 of the exemplary industrial floor environment 300 may include, one or more IoT devices from the IoT sensor set, devices of the coordinated control system, deployment mechanisms for the secondary electromagnetic components, heating and cooling systems for temperature treatments, robotic systems designated by the user within the user interface for the welding of the one or more portions of the workpiece, amongst other devices which may be controlled by the intelligent welding module 150 before, during, and after the welding of the workpiece 302. The devices 306 may be located within the active region/magnetically sensitive repair area 308 of the industrial floor area 310 or outside the active region/magnetically sensitive repair area 308 as depicted by the dashed box. Additionally, the machines or equipment 304 may be moved from inside the active region/magnetically sensitive repair area 308 to outside the active area region within the industrial floor as depicted by magnetic sensitive equipment 312. The intelligent welding module 150 may control the magnetic sensitive equipment 312 and move it safely away from the repair area based on the resultant magnetic field predicted by the one or more machine learning models.

The one or more machine learning models (e.g., simulation models, deep learning models), described in greater detail above at step 204, which may be utilized by the intelligent welding module 150 may include at least Finite Element Method (FEM) based electromagnetic simulations, Monte Carlo simulation processes, convolutional neural networks (CNNs), and/or long short-term memory (LSTM) networks amongst other processes and models. These models in conjunctions with the intelligent welding module 150 may be utilized to control and/or instruct the machines or equipment 304 and the devices 306 before, during, and after the welding process. For example, the one or more machine learning models may require additional data input in performing one or more simulations, the intelligent welding module 150 may direct a specific IoT device represented by at least one of the devices 306 to perform a specific reading or gather specific data needed for input for the one or more machine learning models. In another example, the one or more machine learning models may determine adjustments are required during the welding process. Accordingly, based on the determinations of the one or more machine learning models, the intelligent welding module 150 may utilize one or more of the devices 306 to control for example, the induction heating, cryogenic cooling, or pulsed laser heating systems to maintain optimal thermal gradients and minimize microstructural deviations, ensuring controlled ferrite formation and magnetic property refinement. In another example, the intelligent welding module 150 may utilize the devices 306 to perform post-weld treatments to refine the microstructure and optimize the magnetic properties of the one or more portions of the workpiece 302.

It may be appreciated that FIGS. 2-3 provide only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for intelligent welding, the method comprising:
identifying one or more portions of a workpiece for which welding is to be performed;
generating a plurality of welding parameters;
welding, utilizing a welding device, the one or more portions of the workpiece according to the plurality of welding parameters;
monitoring the welding of the one or more portions of the workpiece based on real-time multi-sensor data received; and
adjusting the welding of the one or more portions of the workpiece in response to the real-time multi-sensor data received.

2. The method of claim 1, wherein generating the plurality of welding parameters further comprises:
generating a digital twin of an industrial floor, wherein the digital twin includes information of the workpiece and real-world capabilities of a plurality of welding devices designated by a user within a user interface.

3. The method of claim 2, wherein the plurality of welding parameters are generated based on trial-and-error simulations of the welding process, wherein the trial-and-error simulations utilize the digital twin and a plurality of historical data as input.

4. The method of claim 1, wherein the welding device is comprised of one or more automated machines, wherein the one or more automated machines are selected from a plurality of welding equipment that are listed in a database, wherein the database includes information about each piece of equipment on the industrial floor, wherein the one or machines are selected based on a plurality of simulations performed by one or more machine learning models.

5. The method of claim 4, wherein the real-time multi-sensor data is received and used as input for the one or more machine learning models, and wherein the welding of the one or more portions of the workpiece is adjusted using the one or more automated machines based on an output of the one or more machine learning models.

6. The method of claim 4, wherein the one or more machine learning models are trained using standard reference samples with known ferrite content and magnetic properties, and wherein the plurality of simulations are validated against experimental data.

7. A computer system for intelligent welding, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more portions of a workpiece for which welding is to be performed;
generating a plurality of welding parameters;
welding, utilizing a welding device, the one or more portions of the workpiece according to the plurality of welding parameters;
monitoring the welding of the one or more portions of the workpiece based on real-time multi-sensor data received; and
adjusting the welding of the one or more portions of the workpiece in response to the real-time multi-sensor data received.

8. The computer system of claim 7, further comprising:
program instructions, stored on at least one of the one or more computer-readable storage media for execution by at least one of the one or more processors via at least one of the one or more memories, to generate a digital twin of an industrial floor, wherein the digital twin includes information of the workpiece and real-world capabilities of a plurality of welding devices designated by a user within a user interface.

9. The computer system of claim 8, wherein the plurality of welding parameters are generated based on trial-and-error simulations of the welding process, wherein the trial-and-error simulations utilize the digital twin and a plurality of historical data as input.

10. The computer system of claim 7, wherein the welding device is comprised of one or more automated machines, wherein the one or more automated machines are selected from a plurality of welding equipment that are listed in a database, wherein the database includes information about each piece of equipment on the industrial floor, wherein the one or machines are selected based on a plurality of simulations performed by one or more machine learning models.

11. The computer system of claim 10, wherein the real-time multi-sensor data is received and used as input for the one or more machine learning models, and wherein the welding of the one or more portions of the workpiece is adjusted using the one or more automated machines based on an output of the one or more machine learning models.

12. The computer system of claim 10, wherein the one or more machine learning models are trained using standard reference samples with known ferrite content and magnetic properties, and wherein the plurality of simulations are validated against experimental data.

13. A computer program product for intelligent welding, comprising:
one or more computer readable storage media, and program instructions collectively stored on the one or more computer readable storage media, the program instructions comprising:
identifying one or more portions of a workpiece for which welding is to be performed;
generating a plurality of welding parameters;
welding, utilizing a welding device, the one or more portions of the workpiece according to the plurality of welding parameters;
monitoring the welding of the one or more portions of the workpiece based on real-time multi-sensor data received; and
adjusting the welding of the one or more portions of the workpiece in response to the real-time multi-sensor data received.

14. The computer program product of claim 13, further comprising:
program instructions, stored on at least one of the one or more computer-readable storage media, to generate a digital twin of an industrial floor, wherein the digital twin includes information of the workpiece and real-world capabilities of a plurality of welding devices designated by a user within a user interface.

15. The computer program product of claim 14, wherein the plurality of welding parameters are generated based on trial-and-error simulations of the welding process, wherein the trial-and-error simulations utilize the digital twin and a plurality of historical data as input.

16. The computer program product of claim 13, wherein the welding device is comprised of one or more automated machines, wherein the one or more automated machines are selected from a plurality of welding equipment that are listed in a database, wherein the database includes information about each piece of equipment on the industrial floor, wherein the one or machines are selected based on a plurality of simulations performed by one or more machine learning models.

17. The computer program product of claim 16, wherein the real-time multi-sensor data is received and used as input for the one or more machine learning models, and wherein the welding of the one or more portions of the workpiece is adjusted using the one or more automated machines based on an output of the one or more machine learning models.

18. The computer program product of claim 16, wherein the one or more machine learning models are trained using standard reference samples with known ferrite content and magnetic properties, and wherein the plurality of simulations are validated against experimental data.

19. A method for managing magnetic properties during welding repair activities, the method comprising:
identifying one or more portions of a workpiece for welding using non-destructive testing techniques to map the workpiece and detect areas requiring repair, wherein the workpiece is located in a repair area of an industrial floor;
simulating effects of potential magnetic field changes prior to the welding being performed;
positioning secondary electromagnetic particles during a welding process to counteract the potential magnetic field changes identified prior to the welding;
integrating a coordinated control system with a welding system to control ferrite formation during the welding process, wherein the coordinated control system includes at least a heating treatment module and a cooling treatment module; and
performing at least one heating treatment or at least one cooling treatment using the coordinated control system during the welding process of the workpiece.

20. The method of claim 19, wherein the simulating of the effects of the potential magnetic field changes prior to the welding further comprises:
generating a digital twin of the workpiece and surrounding magnetic-sensitive equipment in the repair area of the industrial floor using laser scanning technology or photogrammetry; and
integrating the digital twin with historical data and using the digital twin with finite element analysis software to determine the positioning of the secondary electromagnetic particles.

21. The method of claim 19, wherein the cooling treatment module includes a cryogenic colling system for rapid temperature reduction, and wherein the heating treatment module includes an induction heating system for localized heat application, and wherein the coordinated control system is configured to dynamically adjust flow rates of cryogenic coolants and power output of the induction heating system based on real-time temperature measurements received.

22. The method of claim 19, further comprising:
analyzing data from at least one or more magnetic flux sensors and one or more eddy current testers to identify ferrite formation during the welding process; and
implementing at least one post-weld treatment to refine a microstructure and optimize magnetic properties of the one or more portions of the workpiece.

23. A computer system for managing magnetic properties during welding repair activities, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more portions of a workpiece for welding using non-destructive testing techniques to map the workpiece and detect areas requiring repair, wherein the workpiece is located in a repair area of an industrial floor;
simulating effects of potential magnetic field changes prior to the welding being performed;
positioning secondary electromagnetic particles during a welding process to counteract the potential magnetic field changes identified prior to the welding;
integrating a coordinated control system with a welding system to control ferrite formation during the welding process, wherein the coordinated control system includes at least a heating treatment module and a cooling treatment module; and
performing at least one heating treatment or at least one cooling treatment using the coordinated control system during the welding process of the workpiece.

24. The computer system of claim 23, wherein the simulating of the effects of the potential magnetic field changes prior to the welding further comprises:
program instructions, stored on at least one of the one or more computer-readable storage media for execution by at least one of the one or more processors via at least one of the one or more memories, to generate a digital twin of the workpiece and surrounding magnetic-sensitive equipment in the repair area of the industrial floor using laser scanning technology or photogrammetry; and
program instructions, stored on at least one of the one or more computer-readable storage media for execution by at least one of the one or more processors via at least one of the one or more memories, to integrate the digital twin with historical data and using the digital twin with finite element analysis software to determine the positioning of the secondary electromagnetic particles.

25. The computer system of claim 23, wherein the cooling treatment module includes a cryogenic colling system for rapid temperature reduction, and wherein the heating treatment module includes an induction heating system for localized heat application, and wherein the coordinated control system is configured to dynamically adjust flow rates of cryogenic coolants and power output of the induction heating system based on real-time temperature measurements received.
